(19) United States
(12) Patent Application Publication
(10) Pub. No.: US 2019/0038076 A1
(43) Pub. Date: Feb. 7, 2019

(54) Systems, Devices, and/or Methods for Managing Grill Cooking

(71) Applicant: Gerald Thornburg, Alma, NE (US)

(72) Inventor: Gerald Thornburg, Alma, NE (US)

(21) Appl. No.: 15/796,842

(22) Filed: Oct. 29, 2017

Related U.S. Application Data
(60) Provisional application No. 62/541,730, filed on Aug. 6, 2017.

(51) Int. Cl. A47J 37/07

(52) U.S. Cl. CPC A47J 37/0786; A47J 37/0704

(57) ABSTRACT

Certain exemplary embodiments provide a grill. The grill comprises a cooking grid. The cooking grid rests on a frame of the grill substantially without being coupled to the grill. Certain exemplary embodiments provide a handle that is coupleable to the cooking grid. The handle is grippable by a human hand. The handle is constructed to allow a user to lift the cooking grid off of a portion of the grill that is above a burner of the grill.

### CROSS-REFERENCES TO RELATED APPLICATIONS

This application claims priority to, and incorporates by reference herein in its entirety, pending U.S. Provisional Patent Application Ser. No. 62/541,730 (Attorney Docket No. 1231-01), filed Aug. 6, 2017.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system 1000;

FIG. 2 is a perspective view of an exemplary embodiment of a system 2000;

FIG. 3 is a perspective view of an exemplary embodiment of a system 3000;

FIG. 4 is a perspective view of an exemplary embodiment of a system 4000;

FIG. 5 is a perspective view of an exemplary embodiment of a system 5000;

FIG. 6 is a perspective view of an exemplary embodiment of a system 6000;

FIG. 7 is a perspective view of an exemplary embodiment of a system 7000; and

FIG. 8 is a flowchart of an exemplary embodiment of a method 8000.

### DETAILED DESCRIPTION

Certain exemplary embodiments provide a grill. The grill comprises a cooking grid. The cooking grid rests on a frame of the grill substantially without being coupled to the grill. Certain exemplary embodiments provide a handle that is coupleable to the cooking grid. The handle is grippable by a human hand. The handle is constructed to allow a user to lift the cooking grid off of a portion of the grill that is above a burner of the grill.

Placement of a cooking grid on a shelf away from the grill burners can have advantages for a user of a grill. Often, the user can be burned by flames exuding from the grill when placing food on the grill. In addition, fat from meat placed on the grill sometimes ignites, which can burn skin of the user and/or cause meat surfaces to be charred. Placing the cooking grid on the shelf allows the user to place food such as meat on the cooking grid prior to placing the cooking grid over flames of the grill. After placing food on the cooking grid, the cooking grid can be placed on the grill for cooking. Once cooking is completed, the cooking grid can be removed from the grill and placed on the shelf such that food can be removed from the cooking grid away from flames of the grill.

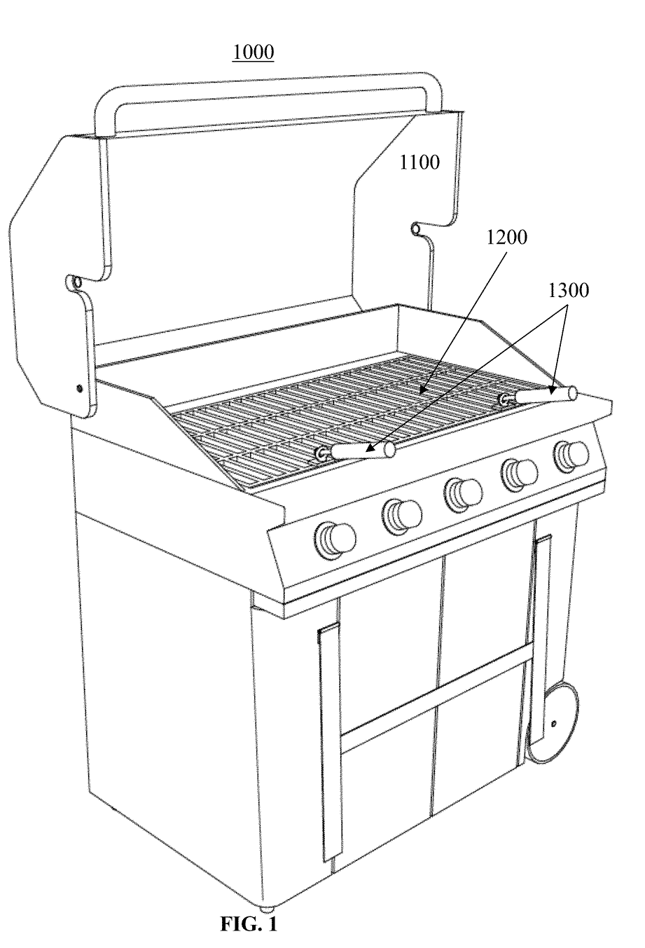

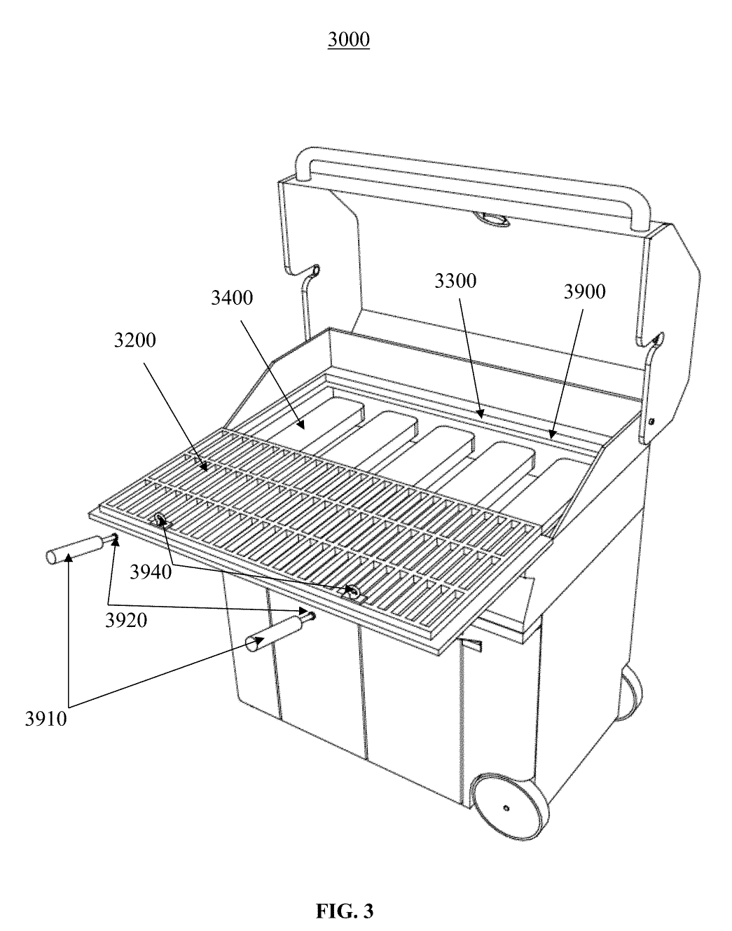

FIG. 1 is a perspective view of an exemplary embodiment of a system 1000. Certain exemplary embodiments provide a grill 1100. Grill comprises a cooking grid 1200. Cooking grid 1200 rests on a frame (see e.g., frame 3300 of FIG. 3) of grill 1100 substantially without being coupled to grill 1100. Certain exemplary embodiments provide a handle 1300 that is coupleable to the cooking grid 1200. Handle 1300 is grippable by a human hand. Handle 1300 is constructed to allow a user to lift cooking grid 1200 off of a portion of grill 1100 that is above a burner (see e.g., burner 3400 of FIG. 3) of grill 1100.

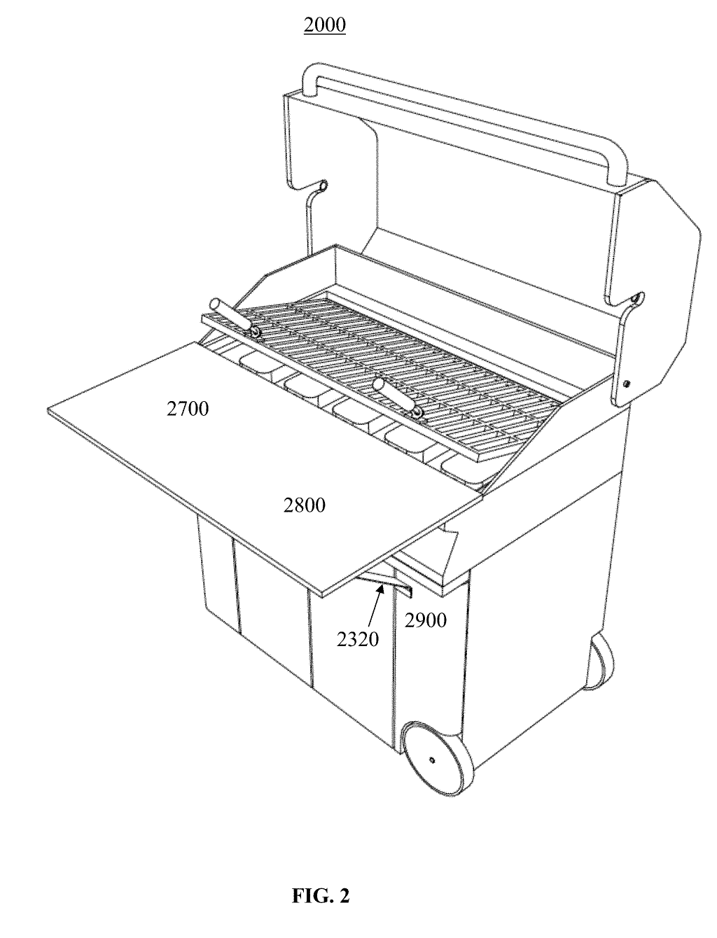

Certain exemplary embodiments provide a system 1000, which comprises a shelf (see e.g., shelf 2700 of FIG. 2) that is coupleable to grill 1100. Wherein grill 1100 comprises cooking grid 1200. The shelf (see e.g., shelf 2700 of FIG. 2) is mountable with its flat surface (see e.g., flat surface 2800 of FIG. 2) at substantially a same elevation as a normal mounted elevation of cooking grid 1200.

The shelf (see e.g., shelf 2700 of FIG. 2) is coupleable to an exterior surface (see e.g., exterior surface 2900 of FIG. 2) of grill 1100. The shelf (see e.g., shelf 2700 of FIG. 2) is coupleable to grill 1100 such that a flat surface (see e.g., flat surface 2800 of FIG. 2) of shelf (see e.g., shelf 2700 of FIG. 2) is at substantially a same elevation as an elevation of cooking grid 1200 when cooking grid 1200 rests on grill 1100 above burner. Wherein the shelf (see e.g., shelf 2700 of FIG. 2) is constructed to receive cooking grid 1200 such that, when on the shelf (see e.g., shelf 2700 of FIG. 2), cooking grid 1200 is not over burner (see e.g., burner 3400 of FIG. 3) of 1100 grill.

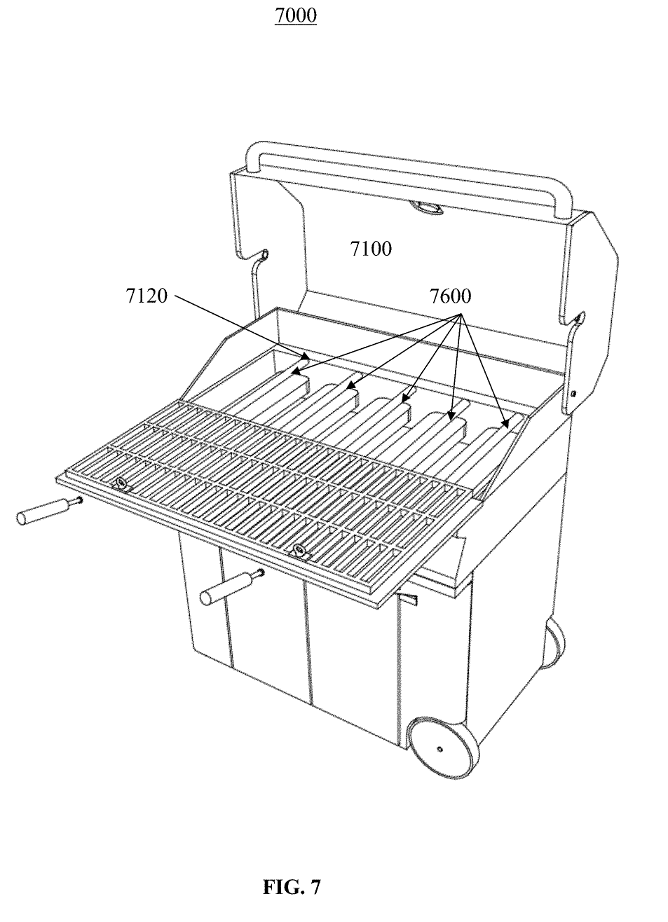

The frame (see e.g., frame 3300 of FIG. 3) can comprise a lip (see e.g., lip 3900 of FIG. 3) on at least two surfaces of grill 1100. The frame (see e.g., frame 3300 of FIG. 3) can comprise a plurality of rods (see e.g., plurality of rods 7600 of FIG. 7). Wherein each of the plurality of rods (see e.g., plurality of rods 7600 of FIG. 7) is coupled to opposing surfaces of grill 1100.

Handle 1300 can comprises a coupling head (see e.g., coupling head 3920 of FIG. 3) and is releasable coupleable to cooking grid 1200 via the coupling head (see e.g., coupling head 3920 of FIG. 3) engaging with an aperture (see e.g., apertures 3940 of FIG. 3) defined by cooking grid 1200.

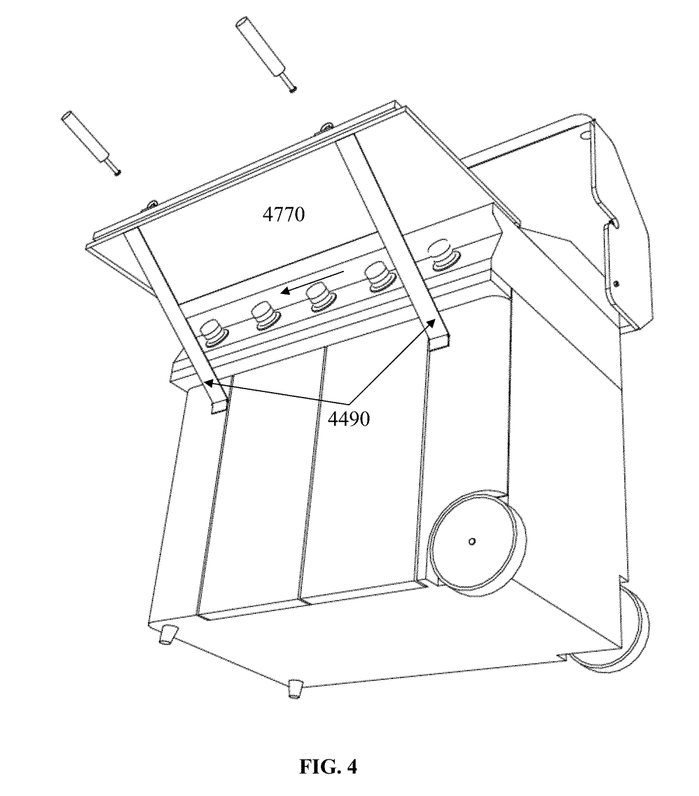

The shelf (see e.g., shelf 2700 of FIG. 2) is supported by a plurality of braces (see e.g., plurality of braces 4490 of FIG. 4), wherein each of the plurality of braces (see e.g., plurality of braces 4490 of FIG. 4) is coupled to grill 1100.

FIG. 2 is a perspective view of an exemplary embodiment of a system 2000, which comprises shelf 2700. Shelf 2700 comprises a flat surface 2800. Shelf 2700 is supported by a pair of braces 2320, one of which is illustrated on FIG. 2.

FIG. 3 is a perspective view of an exemplary embodiment of a system 3000, which illustrates a burner 3400. Frame 3300 utilizes a lip 3900 to support cooking grid 3200. Handles 3910 can each comprise a coupling head 3920 and is releasable coupleable to cooking grid 3200 via coupling head 3920 engaging with an aperture 3940, which aperture is defined by cooking grid 1200.

FIG. 4 is a perspective view of an exemplary embodiment of a system 4000, which comprises shelf 4470. Shelf 4470 is coupled to and/or supported by a plurality of braces 4490.

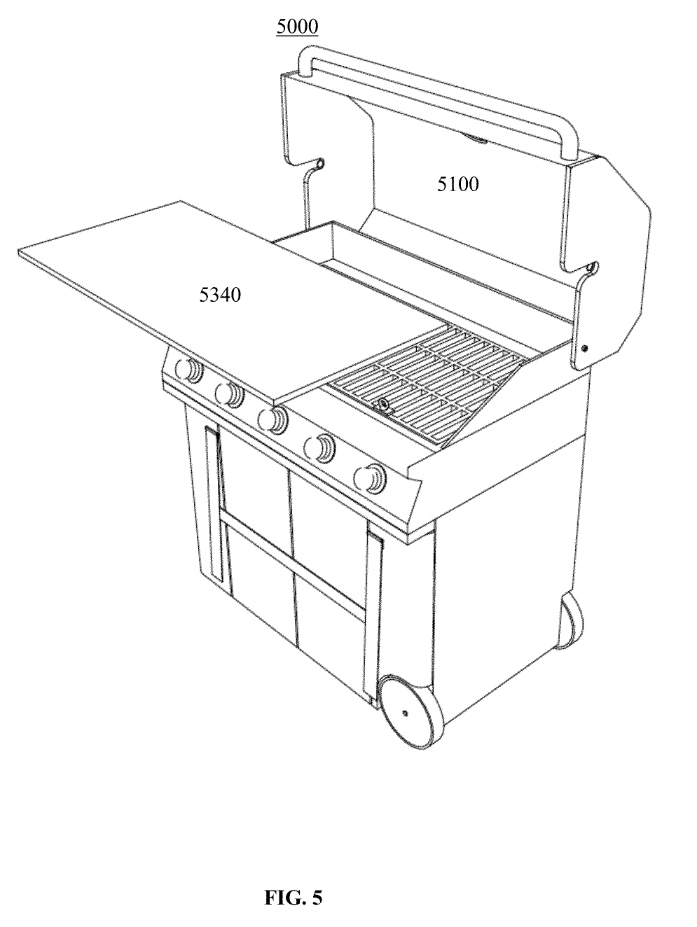

FIG. 5 is a perspective view of an exemplary embodiment of a system 5000, which illustrates shelf 5340 in process of being coupled to grill 5100.

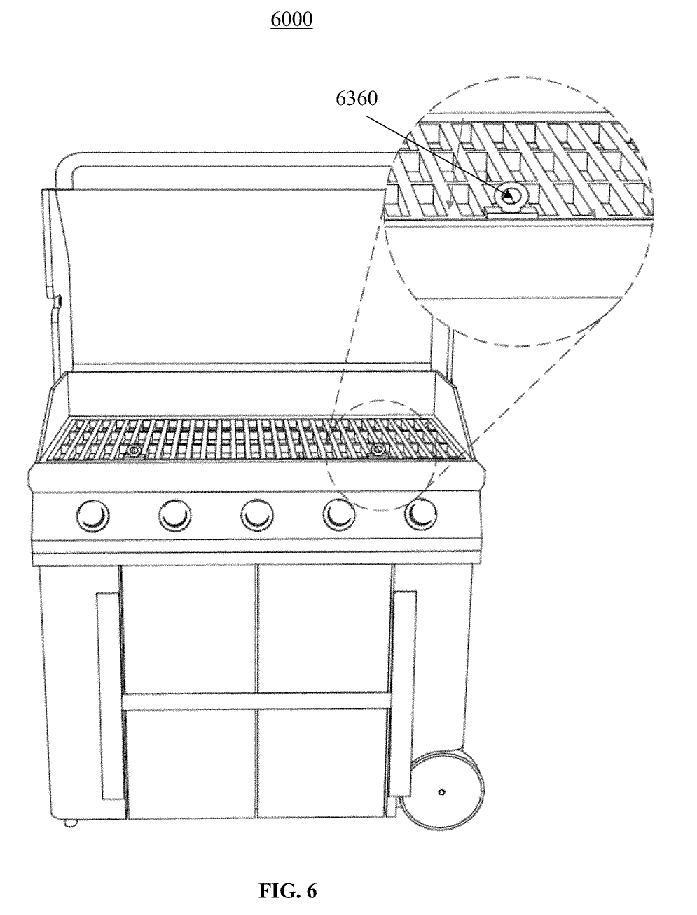

FIG. 6 is a perspective view of an exemplary embodiment of a system 6000, which illustrates an exploded call out of an aperture 6360 defined by system 6000.

FIG. 7 is a perspective view of an exemplary embodiment of a system 7000, which comprises a frame 7120. Frame 7120 defines a plurality of rods 7600. Wherein each of plurality of rods 7600 is coupled to opposing surfaces of grill 7100.

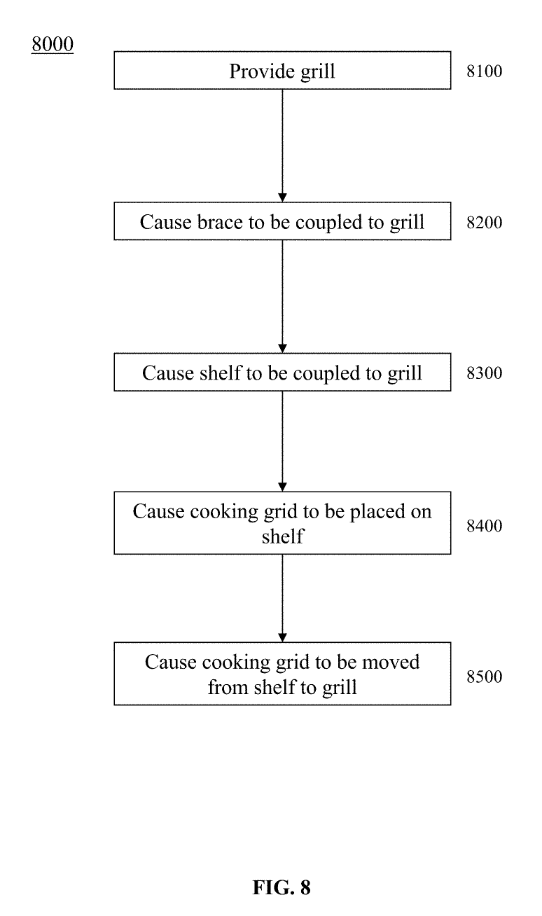

FIG. 8 is a flowchart of an exemplary embodiment of a method 8000. At activity 8100, a grill can be provided. At activity 8200, certain exemplary embodiments can cause a brace to be coupled to a grill. At activity 8300, certain exemplary embodiments can cause the shelf to be coupled to the grill via the brace. At activity 8400, certain exemplary embodiments can cause a cooking grid of the grill to be placed on the shelf. At activity 8500, certain exemplary embodiments can cause cooking grid to be moved from shelf to grill to, for example, begin or stop cooking food on the grill.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
above—higher in elevation relative to the earth's surface.
activity—an action, act, step, and/or process or portion thereof.
adapter—a device used to effect operative compatibility between different parts of one or more pieces of an apparatus or system.
and/or—either in conjunction with or in alternative to.
apparatus—an appliance or device for a particular purpose.
aperture—an opening in something.
associate—to join, connect together, and/or relate.
brace—a device that provides support and thereby restrains something against downward motion caused by gravity.
burner—a grill's heat source.
can—is capable of, in at least some embodiments.
cause—to produce an effect.
comprising—including but not limited to.
configure—to make suitable or fit for a specific use or situation.
connect—to join or fasten together.
constructed to—made to and/or designed to.
convert—to transform, adapt, and/or change.
cooking grid—a framework of spaced bars that are substantially parallels and/or cross each other that is placed on a grill and is constructed for cooking food.
couple—to join, connect, and/or link together.
coupleable—capable of being joined, connected, and/or linked together.
coupling—linking in some fashion.
coupling head—an component constructed to engage with an aperture and thereby releasably couple a handle to a cooking grid.
create—to bring into being.
define—to establish the outline, form, or structure of.
determine—to obtain, calculate, decide, deduce, and/or ascertain.
device—a machine, manufacture, and/or collection thereof.
engage—to move into a location and physically interact with something and thereby control motion of the something.
exterior—situated on an outside of something.
flat—substantially planar.
frame—a supporting structure upon which a cooking grid rests inside of a grill.
grill—a portable device constructed for outdoor cook, the device comprising a cooking grid that is placed over a burner.
grip—to take a firm hold of.
handle—a part by which something is held, carried or controlled by a human hand.
install—to connect or set in position and prepare for use.
lift—to move upward relative to the earth's surface.
lip—an extended piece along an edge of something.
may—is allowed and/or permitted to, in at least some embodiments.
method—a process, procedure, and/or collection of related activities for accomplishing something.
opposing—facing in a spatial sense.
plurality—the state of being plural and/or more than one.
Portion—a part that is less than a whole of something.
predetermined—established in advance.
project—to extend from a surface.
provide—to furnish, supply, give, and/or make available.
receive—to get as a signal, take, acquire, and/or obtain.
rest—to be placed or supported so as to stay in a position substantially via gravity only.
rod—a slender substantially straight piece coupled to two surfaces of a grill.
set—a related plurality.
shelf—a flat part of a grill upon which a cooking grid can be placed.
store—to place, hold, and/or retain.
substantially—to a great extent or degree.
support—to bear the weight of, especially from below.
surface—an outermost layer of something.
system—a collection of mechanisms, devices, machines, articles of manufacture, processes, data, and/or instructions, the collection designed to perform one or more specific functions.
user—a person that operates something.
via—by way of and/or utilizing.
without—not having use or benefit of.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a grill, the grill comprising a cooking grid, the cooking grid resting on a frame of the grill substantially without being coupled to the grill;
a handle that is coupleable to the cooking grid, the handle grippable by a human hand, the handle constructed to allow a user to lift the cooking grid off of a portion of the grill that is above a burner of the grill;
a shelf that is coupleable to an exterior surface of the grill, the shelf couplable to the grill such that a flat surface of the shelf is at substantially a same elevation as an elevation of the cooking grid when the cooking grid rests on the grill above the burner, wherein the shelf is constructed to receive the cooking grid such that, when on the shelf, the cooking grid is not over the burner of the grill.

2. The system of claim 1, wherein:
the frame comprises a lip on at least two surfaces of the grill.

3. The system of claim 1, wherein:
the frame comprises a plurality of rods, wherein each of the plurality of rods is coupled to opposing surfaces of the grill.

4. The system of claim 1, wherein:
the handle comprises a coupling head and is releasable coupleable to the cooking grid via the coupling head engaging with an aperture defined by the cooking grid.

5. The system of claim 1, wherein:
the shelf is supported by a plurality of braces, wherein each of the plurality of braces is coupled to the grill.
